(19) United States
(12) Patent Application Publication
(10) Pub. No.: US 2023/0208232 A1
(43) Pub. Date: Jun. 29, 2023

(54) STATOR, ELECTRIC MOTOR, COMPRESSOR, AND AIR CONDITIONER

(71) Applicant: Mitsubishi Electric Corporation, Tokyo (JP)

(72) Inventors: Atsushi ISHIKAWA, Tokyo (JP); Atsushi MATSUOKA, Tokyo (JP)

(21) Appl. No.: 17/999,088

(22) PCT Filed: Jul. 17, 2020
(86) PCT No.: PCT/JP2020/027798

§ 371 Date: Nov. 17, 2022

(51) Int. Cl. H02K 3/28; H02K 1/16

(52) U.S. Cl. CPC H02K 3/28; H02K 1/16

(57) ABSTRACT

A stator includes a stator core having 9×n (n is an integer equal to or larger than 1) slots and three-phase coils to form 4×n magnetic poles. The three-phase coils include 2×n U-phase coils, 2×n V-phase coils, and 2×n W-phase coils in a coil end. Each of 2×n U-phase coils, 2×n V-phase coils, and 2×n W-phase coils includes n first coil(s) disposed in the stator core at two-slot pitch and n second coils(s) disposed in the stator core at three-slot pitch. The stator satisfies 0.928≤N1/N2<2 or 2<N1/N2≤3.294, where N1 is the number of turns of each of the n first coil(s) and N2 is the number of turns of each of the n second coil(s).

### TECHNICAL FIELD

The present disclosure relates to a stator for an electric motor.

### BACKGROUND ART

A stator including three-phase coils is generally known (see, for example, Patent Reference 1). The stator core disclosed in Patent Reference 1 includes 24 slots, the three-phase coils form eight magnetic poles, and the number of slots to one magnetic pole is three. In this stator, coils of each phase are disposed for each three slots and attached to the stator core with lap winding. Two coils of the same phase are disposed in each slot. In this case, the stator has the advantage of utilizing 100% of magnetic flux from the rotor.

### PRIOR ART REFERENCE

### Patent Reference

Patent Reference 1: Japanese Unexamined Utility Model Registration Application Publication No. S53-114012

### SUMMARY OF THE INVENTION

### Problem to be Solved by the Invention

In general, as a winding factor of a fundamental wave and a winding factor of a harmonic increase, vibrations in an electric motor increase. Although a conventional technique can reduce the winding factor of the harmonic, it also reduces the winding factor of the fundamental wave at the same time. Consequently, sufficient effective magnetic flux in the stator is not obtained, and thus efficiency of the electric motor (also referred to as motor efficiency) decreases.

It is therefore an object of the present disclosure to reduce a winding factor of a harmonic without significantly impairing a winding factor of a fundamental wave in a stator.

### Means of Solving the Problem

A stator according to an aspect of the present disclosure includes: a stator core including 9×n (n is an integer equal to or larger than 1) slots; and three-phase coils attached to the stator core by distributed winding and to form 4×n magnetic poles, wherein the three-phase coils include 2×n U-phase coils, 2×n V-phase coils, and 2×n W-phase coils in a coil end of the three-phase coils, the 2×n U-phase coils are connected in series, the 2×n V-phase coils are connected in series, the 2×n W-phase coils are connected in series, each of the 2×n U-phase coils, the 2×n V-phase coils, and the 2×n W-phase coils includes n first coil(s) disposed in the stator core at two-slot pitch and n second coil(s) disposed in the stator core at three-slot pitch, the n first coil(s) is disposed in the coil end every 360/n degrees in a circumferential direction at regular intervals, the n second coil(s) is disposed in the coil end every 360/n degrees in the circumferential direction at regular intervals, and the stator satisfies 0.928≤N1/N2<2 or 2<N1/N2≤3.294, where N1 is the number of turns of each of the n first coil(s) and N2 is the number of turns of each of the n second coil(s).

A stator according to another aspect of the present disclosure includes: a stator core including 9×n (n is an integer equal to or larger than 1) slots; and three-phase coils attached to the stator core by distributed winding and to form 4×n magnetic poles, wherein the three-phase coils include 2×n U-phase coils, 2×n V-phase coils, and 2×n W-phase coils in a coil end of the three-phase coils, the 2×n U-phase coils are connected in series, the 2×n V-phase coils are connected in series, the 2×n W-phase coils are connected in series, each of the 2×n U-phase coils, the 2×n V-phase coils, and the 2×n W-phase coils includes n first coil(s) disposed in the stator core at two-slot pitch and n second coil(s) disposed in the stator core at three-slot pitch, the n first coil(s) is disposed in the coil end every 360/n degrees in a circumferential direction at regular intervals, the n second coil(s) is disposed in the coil end every 360/n degrees in the circumferential direction at regular intervals, and the stator satisfies 1.117≤N1/N2≤1.634 or 2.244≤N1/N2≤2.876, where N1 is the number of turns of each of the n first coil(s) and N2 is the number of turns of each of the n second coil(s).

A stator according to still another aspect of the present disclosure includes: a stator core including 9×n (n is an integer equal to or larger than 1) slots; and three-phase coils attached to the stator core by distributed winding and to form 4×n magnetic poles, wherein the three-phase coils include 2×n U-phase coils, 2×n V-phase coils, and 2×n W-phase coils in a coil end of the three-phase coils, the 2×n U-phase coils are connected in series, the 2×n V-phase coils are connected in series, the 2×n W-phase coils are connected in series, each of the 2×n U-phase coils, the 2×n V-phase coils, and the 2×n W-phase coils includes n first coil(s) disposed in the stator core at two-slot pitch and n second coil(s) disposed in the stator core at three-slot pitch, the n first coil(s) is disposed in the coil end every 360/n degrees in a circumferential direction at regular intervals, the n second coil(s) is disposed in the coil end every 360/n degrees in the circumferential direction at regular intervals, and the stator satisfies 1.347≤N1/N2≤2.532, where N1 is the number of turns of each of the n first coil(s) and N2 is the number of turns of each of the n second coil(s).

A stator according to yet another aspect of the present disclosure includes: a stator core including 9×n (n is an integer equal to or larger than 1) slots; and three-phase coils attached to the stator core by distributed winding and to form 4×n magnetic poles, wherein the three-phase coils include 2×n U-phase coils, 2×n V-phase coils, and 2×n W-phase coils in a coil end of the three-phase coils, the 2×n U-phase coils are connected in series, the 2×n V-phase coils are connected in series, the 2×n W-phase coils are connected in series, each of the 2×n U-phase coils, the 2×n V-phase coils, and the 2×n W-phase coils includes n first coil(s) disposed in the stator core at two-slot pitch and n second coil(s) disposed in the stator core at three-slot pitch, the n first coil(s) is disposed in the coil end every 360/n degrees in a circumferential direction at regular intervals, the n second coil(s) is disposed in the coil end every 360/n degrees in the circumferential direction at regular intervals, and the stator satisfies 0.928≤N1/N2<2, where N1 is the number of turns of each of the n first coil(s) and N2 is the number of turns of each of the n second coil(s).

A stator according to yet another aspect of the present disclosure includes: a stator core including 9×n (n is an integer equal to or larger than 1) slots; and three-phase coils attached to the stator core by distributed winding and to form 4×n magnetic poles, wherein the three-phase coils include 2×n U-phase coils, 2×n V-phase coils, and 2×n W-phase coils in a coil end of the three-phase coil, the 2×n U-phase coils are connected in series, the 2×n V-phase coils are connected in series, the 2×n W-phase coils are connected in series, each of the 2×n U-phase coils, the 2×n V-phase coils, and the 2×n W-phase coils includes n first coil(s) disposed in the stator core at two-slot pitch and n second coil(s) disposed in the stator core at three-slot pitch, the n first coil(s) is disposed in the coil end every 360/n degrees in a circumferential direction at regular intervals, the n second coil(s) is disposed in the coil end every 360/n degrees in the circumferential direction at regular intervals, and the stator satisfies 2<N1/N2≤3.294, where N1 is the number of turns of each of the n first coil(s) and N2 is the number of turns of each of the n second coil(s).

An electric motor according to another aspect of the present disclosure includes: the stator described above; and a rotor disposed inside the stator.

A compressor according to another aspect of the present disclosure includes: a closed container; a compression device disposed in the closed container; and the electric motor described above to drive the compression device.

An air conditioner according to another aspect of the present disclosure includes: the compressor described above; and a heat exchanger.

### Effects of the Invention

According to the present disclosure, it is possible to reduce a winding factor of a harmonic without significantly impairing a winding factor of a fundamental wave in a stator.

### BRIEF DESCRIPTION OF THE DRAWINGS

FIG. 1 is a top view schematically illustrating a structure of an electric motor according to a first embodiment.

FIG. 2 is a top view schematically illustrating a structure of a stator.

FIG. 3 is a diagram schematically illustrating three-phase coils.

FIG. 4 is a diagram illustrating an example of an inserter for inserting three-phase coils in a stator core.

FIG. 5 is a diagram illustrating an example of a step of inserting three-phase coils in the stator core.

FIG. 6 is a diagram illustrating an example of the step of inserting three-phase coils in the stator core.

FIG. 7 is a top view illustrating an electric motor according to a comparative example.

FIG. 8 is a diagram illustrating arrangement of three-phase coils in slots of a stator illustrated in FIG. 7.

FIG. 9 is a graph showing a winding factor of a fundamental wave.

FIG. 10 is a graph showing a third winding factor.

FIG. 11 is a graph showing an absolute value of a fifth winding factor.

FIG. 12 is a graph showing an absolute value of a seventh winding factor.

FIG. 13 is a graph showing a proportion of a winding factor of a harmonic (specifically fifth and seventh) in a fundamental wave.

FIG. 14 is a graph showing a third winding factor, a fifth winding factor, and a seventh winding factor.

FIG. 15 is a top view schematically illustrating a structure of an electric motor according to a variation.

FIG. 16 is a cross-sectional view schematically illustrating a structure of a rotor of the electric motor according to the variation.

FIG. 17 is a top view schematically illustrating a structure of a stator of the electric motor according to the variation.

FIG. 18 is a diagram illustrating arrangement of three-phase coils in slots of the electric motor according to the variation.

FIG. 19 is a diagram schematically illustrating three-phase coils of the electric motor according to the variation.

FIG. 20 is a cross-sectional view schematically illustrating a structure of a compressor according to a second embodiment.

FIG. 21 is a diagram schematically illustrating a configuration of a refrigeration air conditioning apparatus according to a third embodiment.

### MODE FOR CARRYING OUT THE INVENTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction (z axis), and a y-axis direction (y axis) represents a direction orthogonal to both the z-axis direction and the x-axis direction. The axis Ax is a center of a stator 3, and is a rotation center of a rotor 2. A direction parallel to the axis Ax is also referred to as an “axial direction of the rotor 2” or simply as an “axial direction.” The radial direction refers to a radial direction of the rotor 2 or the stator 3, and is a direction orthogonal to the axis Ax. An xy plane is a plane orthogonal to the axial direction. An arrow D1 represents a circumferential direction about the axis Ax. The circumferential direction of the rotor 2 or the stator 3 will be also referred to simply as a “circumferential direction.”

### <Electric Motor 1>

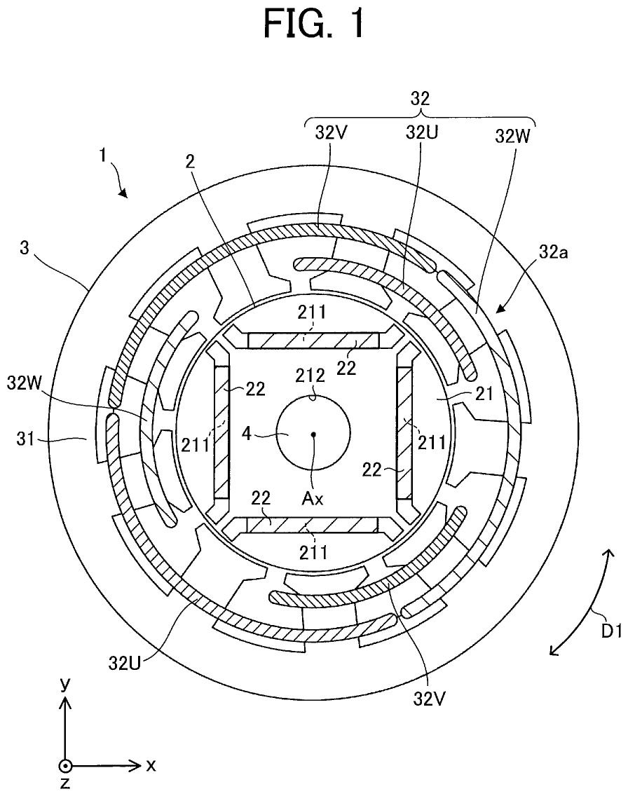

FIG. 1 is a top view schematically illustrating a structure of the electric motor 1 according to a first embodiment.

The electric motor 1 includes the rotor 2 having a plurality of magnetic poles, the stator 3, and a shaft 4 fixed to the rotor 2. The electric motor 1 is, for example, a permanent magnet synchronous motor.

The rotor 2 is rotatably disposed inside the stator 3. An air gap is present between the rotor 2 and the stator 3. The rotor 2 rotates about an axis Ax.

The rotor 2 includes a rotor core 21 and a plurality of permanent magnets 22.

The rotor core 21 includes a plurality of magnet insertion holes 211 and a shaft hole 212 in which the shaft 4 is disposed. The rotor core 21 may further include at least one flux barrier portion that is a space communicating with each of the magnet insertion holes 211.

In this embodiment, the rotor 2 includes the plurality of permanent magnets 22. Each of the permanent magnets 22 is disposed in a corresponding one of the magnet insertion holes 211.

One permanent magnet 22 forms one magnetic pole, that is, a north pole or a south pole, of the rotor 2. It should be noted that two or more permanent magnets 22 may form one magnetic pole of the rotor 2.

In this embodiment, in the xy plane, one permanent magnet 22 forming one magnetic pole of the rotor 2 is disposed straight. Alternatively, in the xy plane, a pair of permanent magnets 22 forming one magnetic pole of the rotor 2 may be disposed in a V shape.

A center of each magnetic pole of the rotor 2 is located at a center of the north pole or the south pole of the rotor 2. Each magnetic pole (hereinafter simply referred to as “each magnetic pole” or a “magnetic pole”) of the rotor 2 refers to a region serving as a north pole or a south pole of the rotor 2.

### <Stator 3>

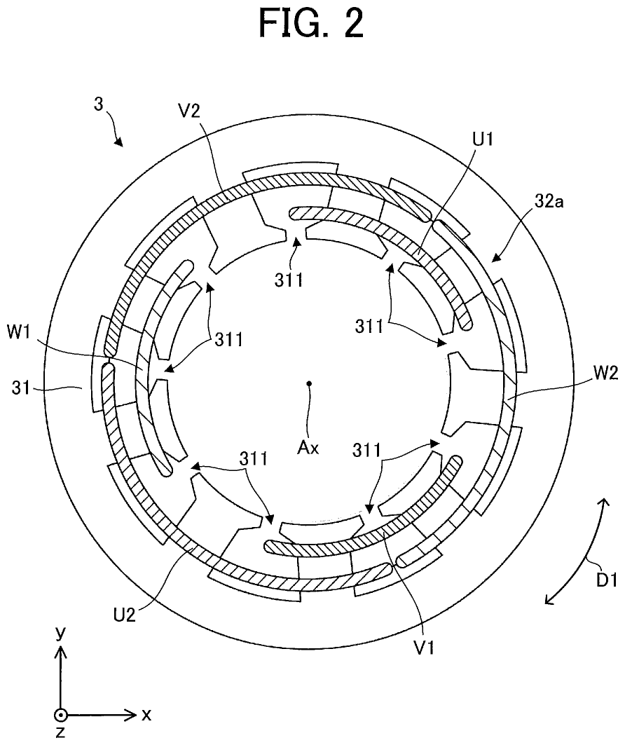

FIG. 2 is a top view schematically illustrating a structure of the stator 3.

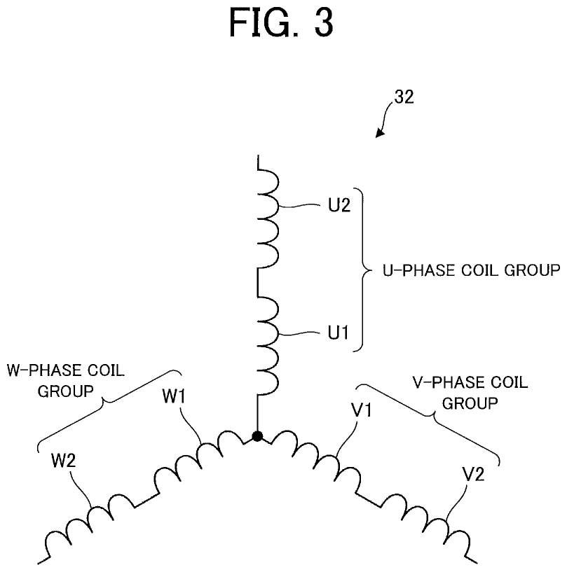

FIG. 3 is a diagram schematically illustrating three-phase coils 32.

As illustrated in FIGS. 1 and 2, the stator 3 includes a stator core 31, and three-phase coils 32 attached to the stator core 31 by distributed winding.

The stator core 31 includes 9×n (n is an integer equal to or larger than 1) slots 311 in which the three-phase coils 32 are disposed. In this embodiment, n=1. Thus, in the example illustrated in FIGS. 1 and 2, the stator core 31 includes nine slots 311.

The three-phase coils 32 (i.e., coils of individual phases) include coil sides disposed in the slots 311 and coil ends 32a not disposed in the slots 311. Each coil end 32a is an end portion of the three-phase coils 32 in the axial direction.

In the coil ends 32a, the three-phase coils 32 include 2×n U-phase coils 32U, 2×n V-phase coils 32V, and 2×n W-phase coils 32W (see FIG. 1). That is, the three-phase coils 32 have three phases of a first phase, a second phase, and a third phase. For example, the first phase is a U phase, the second phase is a V phase, and the third phase is a W phase. In this embodiment, the three phases will be referred to as the U phase, the V phase, and the W phase, respectively. The 2×n coils 32U will also be referred to as a “U-phase coil group,” the 2×n V-phase coils 32V will also be referred to as a “V-phase coil group,” and the 2×n W-phase coils 32W will also be referred to as a “W-phase coil group.” Each of the U-phase coil group, the V-phase coil group, and the W-phase coil group will also be referred to as a “coil group of each phase.”

The coil group of each phase includes n first coil(s) and n second coil(s). The first coils are arranged in the stator core 31 at two-slot pitch. The second coils are arranged in the stator core 31 at three-slot pitch. Each of the first coils and the second coils will also be referred to simply as a “coil.”

The two-slot pitch means “each two slots.” That is, the two-slot pitch means that one coil is disposed for each two slots in the slots 311. In other words, the two-slot pitch means that one coil is disposed in every other slot in the slots 311.

The three-slot pitch means “each three slots.” That is, the three-slot pitch means that one coil is disposed for each three slots in the slots 311. In other words, the three-slot pitch means that one coil is disposed every three slots in the slots 311.

In this embodiment, n=1. Thus, in the example illustrated in FIG. 1, in the coil ends 32a, the three-phase coils 32 include two U-phase coils 32U, two V-phase coils 32V, and two W-phase coils 32W. It should be noted that the number of coils of each phase is not limited to two. In this embodiment, the stator 3 has the structure illustrated in FIG. 1 in two coil ends 32a. It should be noted that the stator 3 only needs to have the structure illustrated in FIG. 1 in one of the two coil ends 32a.

When current flows in the three-phase coils 32, the three-phase coils 32 form 4×n magnetic poles. In this embodiment, n=1. Thus, in this embodiment, when current flows in the three-phase coils 32, the three-phase coils 32 form four magnetic poles.

As illustrated in FIG. 3, the 2×n U-phase coils 32U (i.e., the first coil(s) U1 and the second coil(s) U2), the 2×n V-phase coils 32V (i.e., the first coil(s) V1 and the second coil(s) V2), and the 2×n W-phase coils 32W (i.e., the first coil(s) W1 and the second coil(s) W2) are connected by, for example, Y connection. Alternatively, the 2×n U-phase coils 32U, the 2×n V-phase coils 32V, and the 2×n W-phase coils 32W may be connected by connection other than Y connection, such as delta connection.

The n first coil(s) of each phase is disposed in the coil end 32a every 360/n degrees in the circumferential direction at regular intervals. For example, in the case of n=1, the first coil of each phase is disposed at an arbitrary position in the coil end 32a. The n second coil(s) of each phase is disposed in the coil end 32a every 360/n degrees in the circumferential direction at regular intervals. For example, in the case of n=1, the second coil of each phase is disposed at an arbitrary position in the coil end 32a. Each of the first coils and the second coils will also be referred to simply as a coil.

### <U-Phase Coils 32U>

As illustrated in FIG. 2, the 2×n U-phase coils 32U include n first coil(s) U1 and n second coil(s) U2. In this embodiment, two U-phase coils 32U are constituted by one first coil U1 and one second coil U2. The 2×n U-phase coils 32U are connected in series. Thus, in this embodiment, one first coil U1 and one second coil U2 are connected in series. The first coil U1 is disposed in the stator core 31 at two-slot pitch. The second coil U2 is disposed in the stator core 31 at three-slot pitch.

As illustrated in FIG. 2, the first coil U1 of the U phase is disposed every other slot in two slots 311 on one end side of the stator core 31. In other words, the first coil U1 of the U phase is disposed in two slots 311 with one slot 311 interposed therebetween on one end side of the stator core 31.

As illustrated in FIG. 2, the second coil U2 of the U phase is disposed every three slots in two slots 311 on one end side of the stator core 31. In other words, the second coil U2 of the U phase is disposed in two slots 311 with two slots 311 interposed therebetween on one end side of the stator core 31.

The n first coil(s) U1 of the U phase is disposed in the coil ends 32a every 360/n degrees in the circumferential direction at regular intervals. It should be noted that in the case of n=1, the first coil U1 is disposed at an arbitrary position in the coil end 32a. The n second coil(s) U2 of the U phase is disposed in the coil ends 32a every 360/n degrees in the circumferential direction at regular intervals. It should be noted that in the case of n=1, the second coil U2 is disposed at an arbitrary position in the coil end 32a.

The stator 3 satisfies, for example, 0.928≤N1/N2<2 or 2<N1/N2≤3.294, where N1 is the number of turns of each of the n first coil(s) U1 of the U phase and N2 is the number of turns of each of the n second coil(s) U2 of the U phase.

### <V-Phase Coils 32V>

As illustrated in FIG. 2, the 2×n V-phase coils 32V include n first coil(s) V1 and n second coil(s) V2. In this embodiment, the two V-phase coils 32V are constituted by one first coil V1 and one second coil V2. The 2×n V-phase coils 32V are connected in series. Thus, in this embodiment, one first coil V1 and one second coil V2 are connected in series. The first coil V1 is disposed in the stator core 31 at two-slot pitch. The second coil V2 is disposed in the stator core 31 at three-slot pitch.

As illustrated in FIG. 2, the first coil V1 of the V phase is disposed every other slot in two slots 311 on one end side of the stator core 31. In other words, the first coil V1 of the V phase is disposed in two slots 311 with one slot 311 interposed therebetween on one end side of the stator core 31.

As illustrated in FIG. 2, the second coil V2 of the V phase is disposed every three slots in two slots 311 on one end side of the stator core 31. In other words, the second coil V2 of the V phase is disposed in two slots 311 with two slots 311 interposed therebetween on one end side of the stator core 31.

The n first coil(s) V1 of the V phase is disposed in the coil ends 32a every 360/n degrees in the circumferential direction at regular intervals. It should be noted that in the case of n=1, the first coil V1 is disposed at an arbitrary position in the coil end 32a. The n second coil(s) V2 of the V phase is disposed in the coil ends 32a every 360/n degrees in the circumferential direction at regular intervals. It should be noted that in the case of n=1, the second coil V2 is disposed at an arbitrary position in the coil end 32a.

The stator 3 satisfies, for example, 0.928≤N1/N2<2 or 2<N1/N2≤3.294, where N1 is the number of turns of each of the n first coil(s) V1 of the V phase and N2 is the number of turns of each of the n second coil(s) V2 of the V phase.

### <W-Phase Coils 32W>

As illustrated in FIG. 2, the 2×n W-phase coils 32W include n first coil(s) W1 and n second coil(s) W2. In this embodiment, the two W-phase coils 32W are constituted by one first coil W1 and one second coil W2. The 2×n W-phase coils 32W are connected in series. Thus, in this embodiment, one first coil W1 and one second coil W2 are connected in series. The first coil W1 is disposed in the stator core 31 at two-slot pitch. The second coil W2 is disposed in the stator core 31 at three-slot pitch.

As illustrated in FIG. 2, the first coil W1 of the W phase is disposed every other slot in two slots 311 on one end side of the stator core 31. In other words, the first coil W1 of the W phase is disposed in two slots 311 with one slot 311 interposed therebetween on one end side of the stator core 31.

As illustrated in FIG. 2, the second coil W2 of the W phase is disposed every three slots in two slots 311 on one end side of the stator core 31. In other words, the second coil W2 of the W phase is disposed in two slots 311 with two slots 311 interposed therebetween on one end side of the stator core 31.

The n first coil(s) W1 of the W phase is disposed in the coil ends 32a every 360/n degrees in the circumferential direction at regular intervals. It should be noted that in the case of n=1, the first coil W1 is disposed at an arbitrary position in the coil end 32a. The n second coil(s) W2 of the W phase is disposed in the coil ends 32a every 360/n degrees in the circumferential direction at regular intervals. It should be noted that in the case of n=1, the second coil W2 is disposed at an arbitrary position in the coil end 32a.

The stator 3 satisfies, for example, 0.928≤N1/N2<2 or 2<N1/N2≤3.294, where N1 is the number of turns of each of the n first coil(s) W1 of the W phase and N2 is the number of turns of each of the n second coil(s) W2 of the W phase.

### <Inserter>

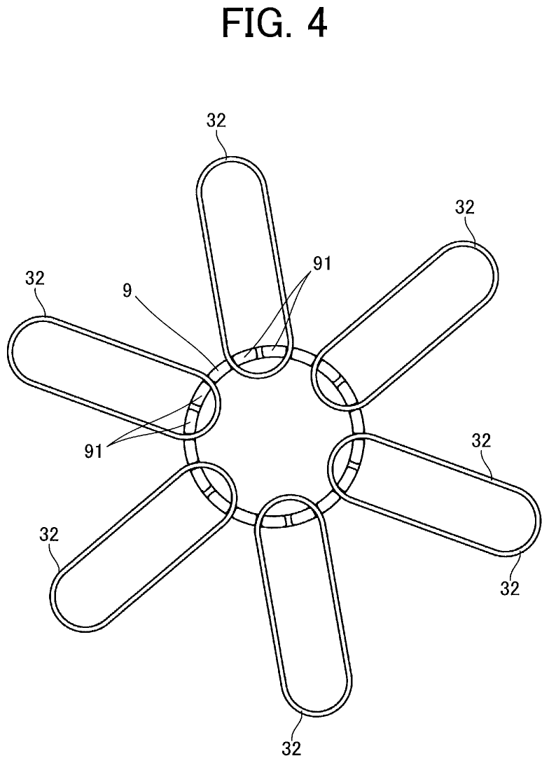

FIG. 4 is a diagram illustrating an example of an inserter 9 for inserting the three-phase coils 32 in the stator core 31.

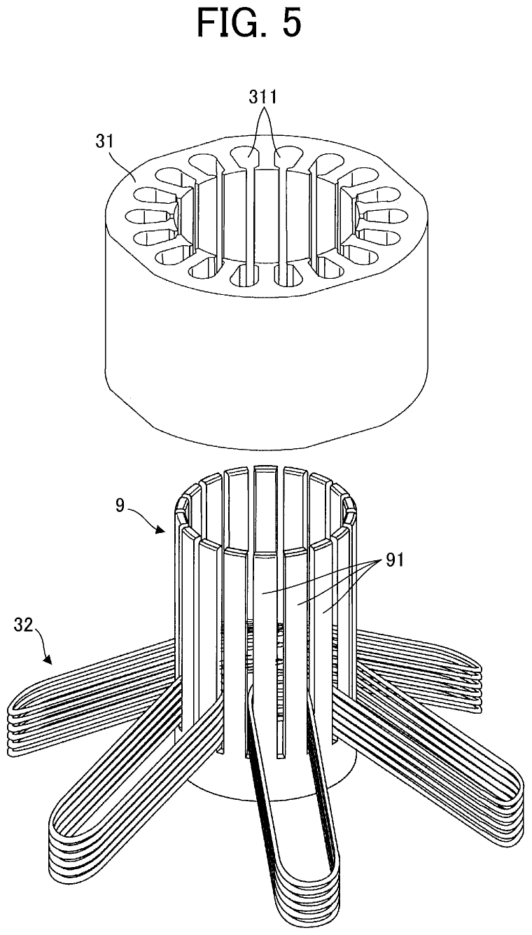

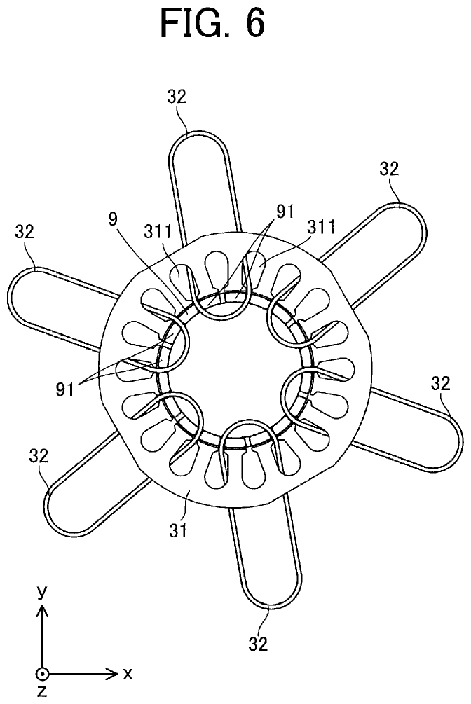

FIGS. 5 and 6 are diagrams showing an example of a step of inserting the three-phase coils in the stator core 31.

The three-phase coils 32 are attached to the previously prepared stator core 31 with the inserter 9, for example. In this embodiment, the three-phase coils 32 are attached to the stator core 31 by distributed winding. In the case of inserting the three-phase coils 32 in the stator core 31 with the inserter 9 illustrated in FIG. 4, as illustrated in FIGS. 5 and 6, the three-phase coils 32 are disposed between blades 91 of the inserter 9, and the blades 91 are inserted in the inside of the stator core 31 together with the three-phase coils 32. Next, the three-phase coils 32 are slid in the axial direction to be disposed in the slots 311.

### Comparative Example

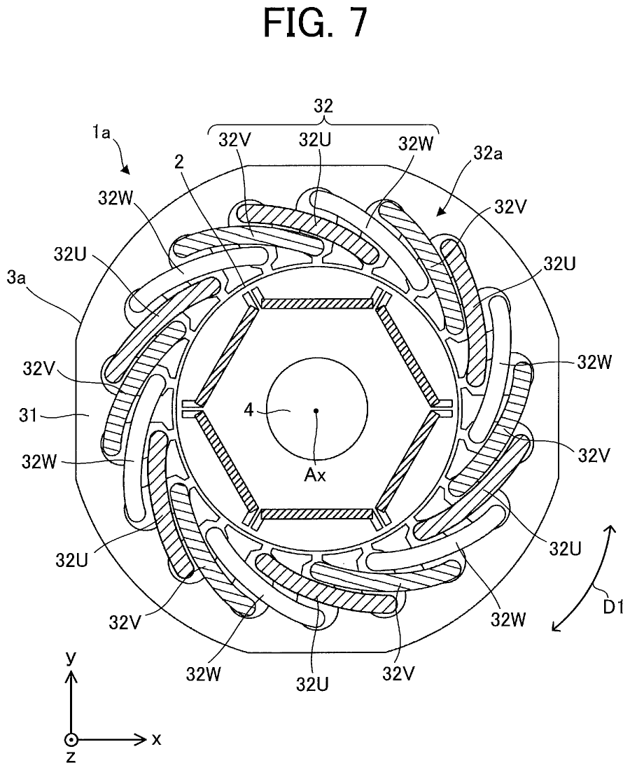

FIG. 7 is a top view illustrating an electric motor 1a according to a comparative example.

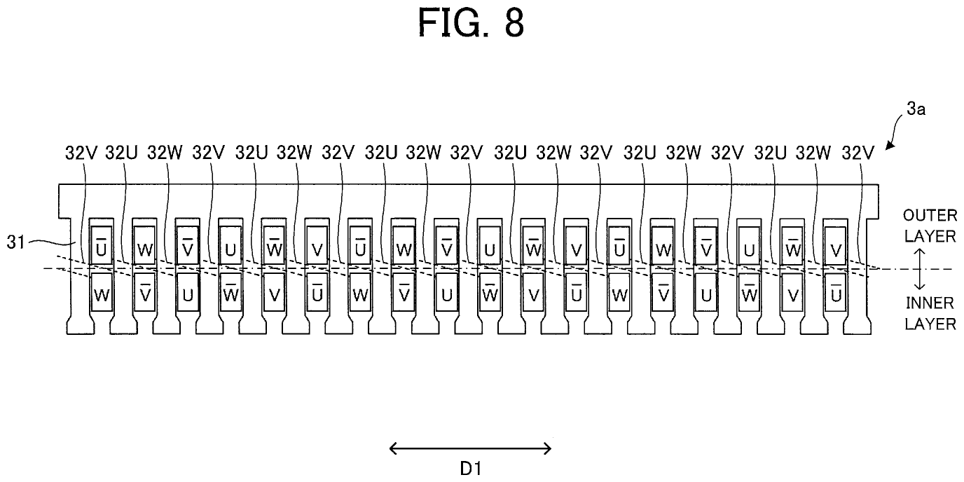

FIG. 8 is a diagram illustrating arrangement of three-phase coils 32 in slots of the stator 3a illustrated in FIG. 7.

FIG. 8 is a development view of the stator 3a illustrated in FIG. 7.

In the comparative example, the three-phase coils 32 are attached to a stator core 31 with lap winding. In this case, in coil ends 32a, one end of each coil is disposed in an outer layer of a slot 311, and the other end of the coil is disposed in an inner layer of another slot 311.

Thus, in the case of attaching the three-phase coils 32 to the stator core 31 with lap winding, it is difficult to attach the three-phase coils 32 to the stator core 31 by using an inserter (e.g., the inserter 9 illustrated in FIG. 4). Thus, in general, in the case of attaching the three-phase coils 32 to the stator core 31 with lap winding as described in the comparative example, the three-phase coils 32 are manually attached to the stator core. In this case, productivity of the stator 3 decreases.

In the case of disposing two coils in each slot, an inductance difference occurs between the two coils in the slot. In this case, current flowing in three-phase coils varies among the phases during driving of the electric motor, and thus current easily flows in a phase with a large inductance and does not easily flow in a phase with a small inductance. Consequently, torque ripples occur.

### <Winding Factor>

In this embodiment, a winding factor of the first coil(s) is different from a winding factor of the second coil(s) in each phase. Thus, to calculate a winding factor of the stator 3 of the electric motor 1, the winding factor of the first coil(s) of each phase and the winding factor of the second coil(s) of each phase are calculated.

A distributed winding factor of the stator 3 of the electric motor 1 is 1, irrespective of a fundamental wave or a harmonic. The winding factor is obtained by a product of a distributed winding factor and a short-pitch factor. Since the distributed winding factor of the stator 3 of the electric motor 1 is 1, the winding factor is equal to the short-pitch factor in this embodiment.

A m-th order short-pitch factor Kp_m (where m represents an order) is obtained by the following Equation (1):

Kp_m=cos{(m×π)/2}×(1−β)} (1)

where β is a short-pitch degree and is defined by “coil pitch/the number of slots for each pole.” In this embodiment, the number of slots for each pole is 9n/4n=9/4=2.25. Thus, a short-pitch degree β1 of the first coil(s) of each phase and a short-pitch degree β2 of the second coil(s) of each phase are respectively obtained by the following Equations (2) and (3):

β1=2/(9/4)=8/9 (2)

β2=3/(9/4)=4/3 (3)

A short-pitch factor Kp of the stator 3 of the electric motor 1 is obtained by the following Equation (4):

$$\begin{matrix}Kp = Kp 1 \times \{ N 1 / ( N 1 + N 2 ) \} + Kp 2 \times \{ N 2 / ( N 1 + N 2 ) \} \\ = Kp 1 \times [ ( N 1 / N 2 ) / \{ ( N 1 / N 2 ) + 1 \} ] + Kp 2 \times [ 1 / \{ ( N 1 / N 2 ) + 1 \} ] \\ = [ 1 / \{ ( N 1 / N 2 ) + 1 \} ] \times \{ ( N 1 / N 2 ) \times Kp 1 + Kp 2 \}\end{matrix} \qquad ( 4 )$$

where N1 is the number of turns of each of the first coil(s) of each phase, N2 is the number of turns of each of the second coil(s) of each phase, Kp1 is a short-pitch factor of each of the first coil(s) of each phase, and Kp2 is a short-pitch factor of each of the second coil(s) of each phase.

From Equations (1) and (4), a winding factor Kp1_1 of a fundamental wave of each of the first coil(s) of each phase, a winding factor Kp2_1 of a fundamental wave of each of the second coil(s) of each phase, and a winding factor Kp_1 of a fundamental wave of the stator 3 of the electric motor 1 are obtained by the following Equations (5), (6), and (7):

$$\begin{matrix}\begin{matrix}Kp 1 \_ 1 = cos \{ ( π / 2 ) \times ( 1 - β1 ) \} \\ = cos \{ ( π / 2 ) \times ( 1 - ( 8 / 9 ) \} \\ = cos ( π / 18 ) \\ = cos 10 °\end{matrix} & ( 5 ) \\ \begin{matrix}Kp 2 \_ 1 = cos \{ ( π / 2 ) \times ( 1 - β2 ) \} \\ = cos \{ ( π / 2 ) \times ( 1 - ( 4 / 3 ) \} \\ = cos ( π / 6 ) \\ = cos 30 °\end{matrix} & ( 6 ) \\ \begin{matrix}Kp\_ 1 = [ 1 / \{ ( N 1 / N 2 ) + 1 \} ] \times \{ ( N 1 / N 2 ) \times Kp 1 \_ 1 + Kp 2 \_ 1 \} \\ = [ 1 / \{ ( N 1 / N 2 ) + 1 \} ] \times \{ ( N 1 / N 2 ) \times cos 10 ° + cos 30 ° \}\end{matrix} & ( 7 )\end{matrix}$$

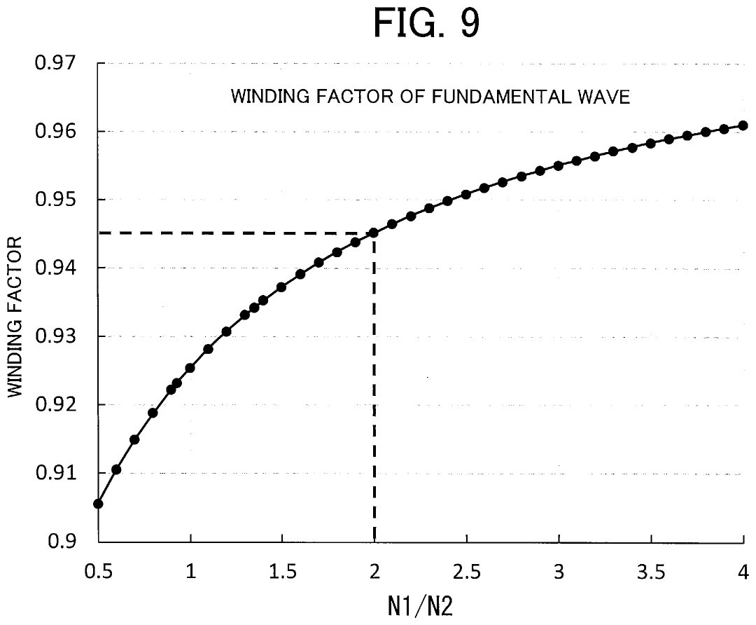

FIG. 9 is a graph showing a winding factor of a fundamental wave.

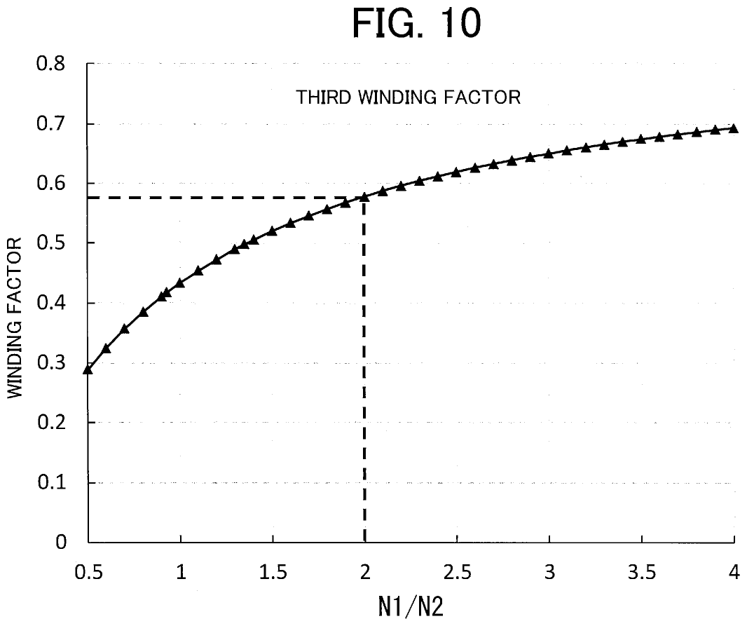

FIG. 10 is a graph showing a third winding factor.

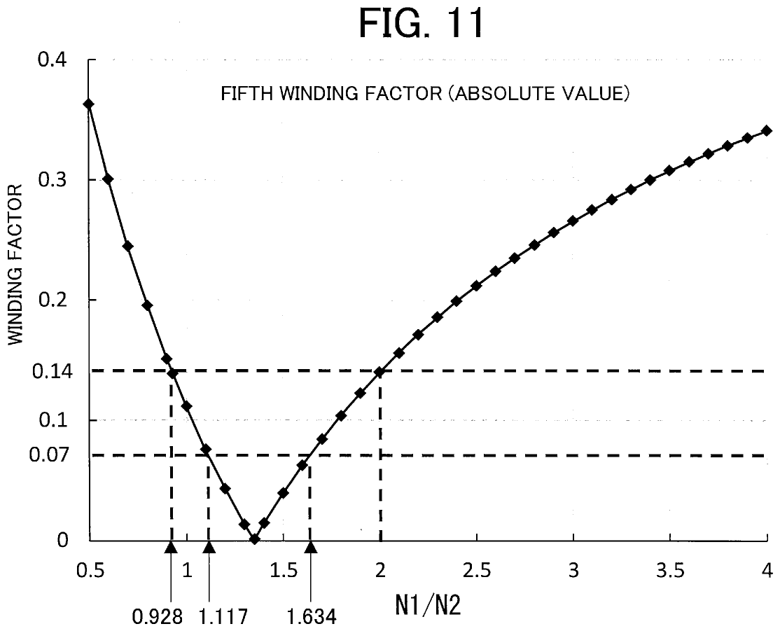

FIG. 11 is a graph showing an absolute value of a fifth winding factor.

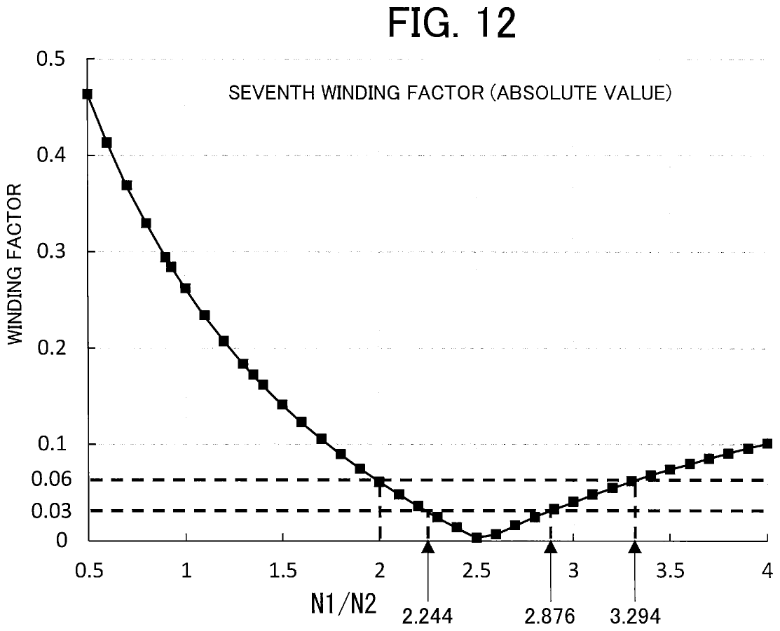

FIG. 12 is a graph showing an absolute value of a seventh winding factor.

As shown in FIG. 9, in the case of N1/N2=2, for example, Kp_1 is 0.945 from Equation (8):

$$\begin{matrix}Kp\_ 1 = \{ 1 / ( 2 + 1 ) \} \times ( 2 \times Kp 1 \_ 1 + Kp 2 \_ 1 ) \\ = ( 1 / 3 ) \times ( 2 \times cos 10 ° + cos 30 ° ) \\ = 0.945\end{matrix} \qquad ( 8 )$$

Harmonic components to be considered in order to reduce torque ripples that are a main cause of vibrations in the electric motor 1 will be described. The torque of the electric motor 1 is proportional to the product of an induced voltage occurring in the three-phase coils 32 and a motor current. For example, both the induced voltage and the motor current are expressed as ideal sinusoidal waves, no torque ripples due to a harmonic occur in the electric motor 1. However, when a harmonic is superimposed on the induced voltage and the motor current, the torque of the electric motor 1 pulses, and thus torque ripples occur.

In torque ripples, a sixth-order component as an electric order is dominant. Assuming that the number of pole pairs is P, the sixth-order component as an electric order appears as a 6×P-th component as a mechanical order.

As described above, the torque of the electric motor 1 is proportional to the product of the induced voltage and the motor current occurring in the three-phase coils 32. Thus, a main cause of a sixth-order torque ripple as an electric order can be a harmonic component of a flux linkage or a harmonic component of a motor current. Generation conditions of the sixth-order torque ripple include the following four conditions:

(A) primary magnetic flux×fifth current

(B) primary magnetic flux×seventh current

(C) fifth magnetic flux×primary current

(D) seventh magnetic flux×primary current

In magnetic flux containing harmonics or currents containing harmonics, the percentage of a constituent of lower order harmonics tends to be high. In view of this, it is preferable to reduce a fifth winding factor as compared to a seventh winding factor. Thus, N1/N2 for reducing harmonics (specifically fifth and seventh) as a main cause of a torque ripple is calculated.

From Equations (1) and (4), a fifth winding factor Kp1_5 of each of the first coil(s) of each phase, a fifth winding factor Kp2_5 of each of the second coil(s) of each phase, and a fifth winding factor Kp_5 of the stator 3 of the electric motor 1 are obtained by the following Equations (9), (10), and (11):

$$\begin{matrix}\begin{matrix}Kp 1 \_ 5 = cos \{ ( 5 π / 2 ) \times ( 1 - β1 ) \} \\ = cos \{ ( 5 π / 2 ) \times ( 1 - ( 8 / 9 ) \} \\ = cos ( 5 π / 18 ) \\ = cos 50 °\end{matrix} & ( 9 ) \\ \begin{matrix}Kp 2 \_ 5 = cos \{ ( 5 π / 2 ) \times ( 1 - β2 ) \} \\ = cos \{ ( 5 π / 2 ) \times ( 1 - ( 4 / 3 ) \} \\ = cos ( 5 π / 6 ) \\ = cos 150 °\end{matrix} & ( 10 ) \\ \begin{matrix}Kp\_ 5 = [ 1 / \{ ( N 1 / N 2 ) + 1 \} ] \times \{ ( N 1 / N 2 ) \times Kp 1 \_ 5 + Kp 2 \_ 5 \} \\ = [ 1 / \{ ( N 1 / N 2 ) + 1 \} ] \times \{ ( N 1 / N 2 ) \times cos 50 ° + cos 150 ° \}\end{matrix} & ( 11 )\end{matrix}$$

In the case of N1/N2=2, for example, Kp 5 is 0.14 from Equation (12):

$$\begin{matrix}Kp\_ 5 = \{ 1 / ( 2 + 1 ) \} \times ( 2 \times Kp 1 \_ 5 + Kp 2 \_ 5 ) \\ = ( 1 / 3 ) \times ( 2 \times cos 50 ° + cos 150 ° ) \\ = 0.14\end{matrix} \qquad ( 12 )$$

From Equations (1) and (4), a seventh winding factor Kp1_7 of each of the first coil(s) of each phase, a seventh winding factor Kp2_7 of each of the second coil(s) of each phase, and a seventh winding factor Kp_7 of the stator 3 of the electric motor 1 are obtained by the following Equations (13), (14), and (15).

$$\begin{matrix}\begin{matrix}Kp 1 \_ 7 = cos \{ ( 7 π / 2 ) \times ( 1 - β1 ) \} \\ = cos \{ ( 7 π / 2 ) \times ( 1 - ( 8 / 9 ) \} \\ = cos ( 7 π / 18 ) \\ = cos 70 °\end{matrix} & ( 13 ) \\ \begin{matrix}Kp 2 \_ 7 = cos \{ ( 7 π / 2 ) \times ( 1 - β2 ) \} \\ = cos \{ ( 7 π / 2 ) \times ( 1 - ( 4 / 3 ) \} \\ = cos ( 7 π / 6 ) \\ = cos 210 °\end{matrix} & ( 14 ) \\ \begin{matrix}Kp\_ 7 = [ 1 / \{ ( N 1 / N 2 ) + 1 \} ] \times \{ ( N 1 / N 2 ) \times Kp 1 \_ 7 + Kp 2 \_ 7 \} \\ = [ 1 / \{ ( N 1 / N 2 ) + 1 \} ] \times \{ ( N 1 / N 2 ) \times cos 70 ° + cos 210 ° \}\end{matrix} & ( 15 )\end{matrix}$$

In the case of N1/N2=2, for example, Kp_7 is −0.061 from Equation (16).

$$\begin{matrix}Kp\_ 7 = \{ 1 / ( 2 + 1 ) \} \times ( 2 \times Kp 1 \_ 7 + Kp 2 \_ 7 ) \\ = ( 1 / 3 ) \times ( 2 \times cos 70 ° + cos 210 ° ) \\ = - 0.061\end{matrix} \qquad ( 16 )$$

A ratio N1/N2 for reducing a fifth winding factor and a seventh winding factor is calculated.

Assuming that a winding factor Kp is a function of N1/N2, the function is expressed as Kp(N1/N2). In this case, the ratio N1/N2 that yields a fifth winding factor smaller than a fifth winding factor Kp_5(2) in the case of N1/N2=2 is calculated by Equations (17), (18), and (19). Let γ5 be a lower limit of the ratio N1/N2 that yields a fifth winding factor smaller than the fifth winding factor Kp_5(2) in the case of N1/N2=2.

−Kp_5(γ5)≤Kp_5(2) (17)

−{1/(γ5+1)}×(γ5×cos 50°+cos 150°)={1/(2+1)}×(2×cos 50°+cos 150°) (18)

γ5=(2×cos 50°+4×cos 150°)/(−5×cos 50°−cos 150°)=0.928 (19)

From Equations (17), (18), and (19), a condition for the ratio N1/N2 that yields a fifth winding factor smaller than the fifth winding factor Kp_5(2) in the case of N1/N2=2 is 0.928≤N1/N2<2.

Thus, if the ratio N1/N2 satisfies 0.928≤N1/N2<2, it is possible to reduce a fifth winding factor as compared to the comparative example (e.g., N1/N2=2), without significantly impairing a winding factor of a fundamental wave in the stator 3. Consequently, torque ripples in the electric motor 1 can be reduced, and a decrease in efficiency of the electric motor 1 can be prevented.

A ratio N1/N2 that yields a seventh winding factor smaller than a seventh winding factor Kp_7(2) in the case of N1/N2=2 is calculated by the following Equations (20), (21), and (22). Let γ7 be an upper limit of the ratio N1/N2 that yields a seventh winding factor smaller than the seventh winding factor Kp_7(2) in the case of N1/N2=2.

−Kp_7(γ7)≤Kp_7(2) (20)

−{1/(γ7+1)}×(γ7×cos 70°+cos 210°)={1/(2+1)}×(2×cos 70°+cos 210°) (21)

γ7=(2×cos 70°+4×cos 210°)/(−5×cos 70°−cos 210°)=3.294 (22)

From Equations (20), (21), and (22), a condition for the ratio N1/N2 that yields a seventh winding factor smaller than the seventh winding factor Kp_7(2) in the case of N1/N2=2 is obtained is 2<N1/N2≤3.294.

Thus, if the ratio N1/N2 satisfies 2<N1/N2≤3.294, it is possible to reduce a seventh winding factor as compared to the comparative example (e.g., N1/N2=2), without significantly impairing a winding factor of a fundamental wave in the stator 3. Consequently, torque ripples in the electric motor 1 can be reduced, and a decrease in efficiency of the electric motor 1 can be prevented.

As described above, if the ratio N1/N2 satisfies 0.928≤N1/N2<2 or 2<N1/N2≤3.294, a winding factor of a harmonic can be reduced as compared to the comparative example (e.g., N1/N2=2) without significantly impairing a winding factor of a fundamental wave in the stator 3. In this case, at least the fifth winding factor or the seventh winding factor can be reduced. Consequently, torque ripples in the electric motor 1 can be reduced, and a decrease in efficiency of the electric motor 1 can be prevented.

In general, a third harmonic is a cause of generating a cyclic current in three-phase coils connected by delta connection. Thus, the third harmonic is preferably as low as possible. As shown in FIG. 10, if N1/N2<2, a third winding factor can be sufficiently reduced. Thus, if the ratio N1/N2 satisfies 0.928≤N1/N2<2, a cyclic current in three-phase coils connected by delta connection can be reduced.

<Calculation of ε5a>

A ratio N1/N2 for further reducing a fifth winding factor is calculated. As an example, a range of the ratio N1/N2 that yields a fifth winding factor less than or equal to a half of the fifth winding factor Kp_5(2) in the case of N1/N2=2 is calculated.

Assuming that a winding factor Kp is a function of N1/N2, the function is expressed as Kp(N1/N2). In this case, the range of the ratio N1/N2 that yields a fifth winding factor less than or equal to a half of the fifth winding factor Kp_5(2) in the case of N1/N2=2 is calculated by the following Equations (23) through (28): where ε5a is a lower limit of the ratio N1/N2 that yields a fifth winding factor less than or equal to a half of the fifth winding factor Kp_5(2) in the case of N1/N2=2.

Kp_5(ε5a)≤−(½)×Kp_5(2) (23)

{1/(ε5a+1)}×(ε5a×cos 50°+cos 150°)=−(½)×{1/(2+1)}×(2×cos 50°+cos 150°) (24)

ε5a=(−2×cos 50°−7×cos 150°)/(8×cos 50°+cos 150°)=1.117 (25)

Let ε5b be the ratio N1/N2 that satisfies Kp_5(N1/N2)≤(½)×Kp_5(2).

Kp_5(ε5b)≤(½)×Kp_5(2) (26)

{1/(ε5b+1)}×(ε5b×cos 50°+cos 150°)=(½)×{1/(2+1)}×(2×cos 50°+cos 150°) (27)

ε5b=(2×cos 50°−5×cos 150°)/(4×cos 50°−cos 150°)=1.634 (28)

As shown in FIG. 11, the range of the ratio N1/N2 that yields a fifth winding factor less than or equal to a half of the fifth winding factor Kp_5(2) in the case of N1/N2=2 is 1.117≤N1/N2 S 1.634.

<Calculation of ε7a>

A ratio N1/N2 for further reducing a seventh winding factor is calculated. As an example, a range of the ratio N1/N2 that yields a seventh winding factor less than or equal to a half of the seventh winding factor Kp_7(2) in the case of N1/N2=2 is calculated.

Assuming that a winding factor Kp is a function of N1/N2, the function is expressed as Kp(N1/N2). In this case, the range of the ratio N1/N2 that yields a seventh winding factor less than or equal to a half of the seventh winding factor Kp_7(2) in the case of N1/N2=2 is calculated by the following Equations (29) through (34): where ε7a is a lower limit of the ratio N1/N2 that yields a seventh winding factor less than or equal to a half of the seventh winding factor Kp_7(2) in the case of N1/N2=2.

Kp_7(ε7a)≤(½)×Kp_7(2) (29)

{1/(ε7a+1)}×(ε7a×cos 70°+cos 210°)=(½)×{1/(2+1)}×(2×cos 70°+cos 210°) (30)

ε7a=(2×cos 70°−5×cos 210°)/(4×cos 70°−cos 210°)=2.244 (31)

Let ε7b be an upper limit of the ratio N1/N2 that yields a seventh winding factor less than or equal to a half of the seventh winding factor Kp_7(2) in the case of N1/N2=2.

Kp_7(ε7b)≤−(½)×Kp_7(2) (32)

{1/(ε7b+1)}×(ε7b×cos 70°+cos 210°)=−(½)×{1/(2+1)}×(2×cos 70°+cos 210°) (33)

ε7b=(−2×cos 70°−7×cos 210°)/(8×cos 70°+cos 210°)=2.876 (34)

As shown in FIG. 12, the range of the ratio N1/N2 that yields a seventh winding factor less than or equal to a half of the seventh winding factor Kp_7(2) in the case of N1/N2=2 is 2.244≤N1/N2≤2.876.

Thus, if the stator 3 of the electric motor 1 satisfies 1.117≤N1/N2≤1.634 or 2.244≤N1/N2≤2.876, at least a fifth winding factor or a seventh winding factor can be reduced to be less than or equal to a half of that in the comparative example (e.g., N1/N2=2).

### <Calculation of α5 and α7>

A range of the ratio N1/N2 for appropriately reducing both a fifth winding factor and a seventh winding factor is calculated.

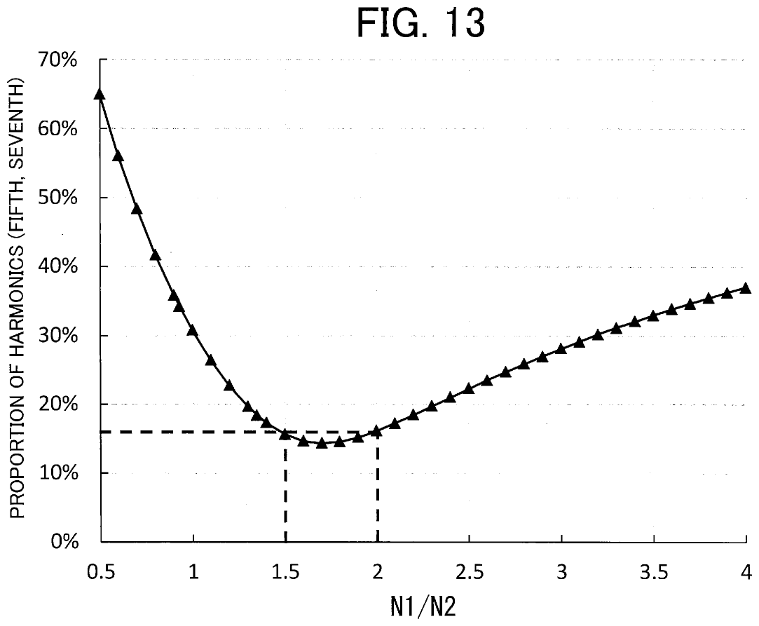

FIG. 13 is a graph showing a proportion of winding factors of harmonics (specifically fifth and seventh) in a fundamental wave.

A proportion γ is obtained by the following Equation (35):

γ=√[{(Kp_5)²+(Kp_7)²)}/Kp_1] (35)

Let α5 be N1/N2 with which a fifth winding factor is zero. That is, N1/N2 that satisfies Kp_5(N1/N2)=0 is α5. In this case, Equation (11) is converted to Equation (36) below:

{1/(α5+1)}×(α5×cos 50°+cos 150°)=0 (36)

From α5>0, Equation (36) is converted to the following Equations (37) and (38):

α5×cos 50°+cos 150°=0 (37)

α5=−cos 150°/cos 50°=1.347 (38)

Thus, the ratio N1/N2 that satisfies Kp_5(N1/N2)=0 is 1.347.

Let α7 be N1/N2 with which a seventh winding factor is zero. That is, N1/N2 that satisfies Kp_7(N1/N2)=0 is α7. In this case, Equation (15) is converted to Equation (39) below:

{1/(α7+1)}×(α7×cos 70°+cos 210°)=0 (39)

From α7>0, Equation (39) is converted to the following Equations (40) and (41):

α7×cos 70°+cos 210°=0 (40)

α7=−cos 210°/cos 70°=2.532 (41)

Thus, the ratio N1/N2 that satisfies Kp_7(N1/N2)=0 is 2.532.

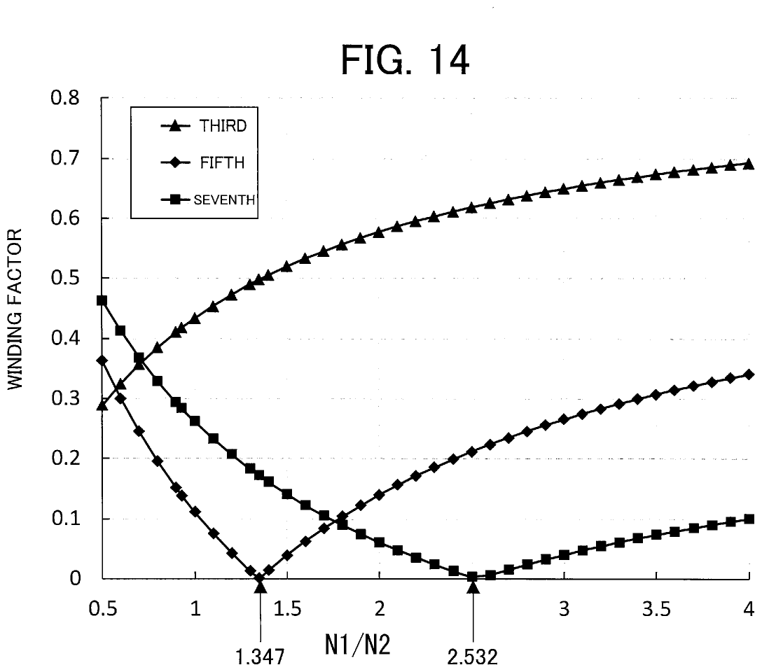

FIG. 14 is a graph showing a third winding factor, a fifth winding factor, and a seventh winding factor.

As shown in FIG. 14, if the stator 3 of the electric motor 1 satisfies 1.347≤N1/N2≤2.532, both a fifth winding factor and a seventh winding factor can be reduced, and a proportion of winding factors of harmonics (specifically fifth and seventh) in a fundamental wave can be reduced.

### Variation

<Electric motor 1>

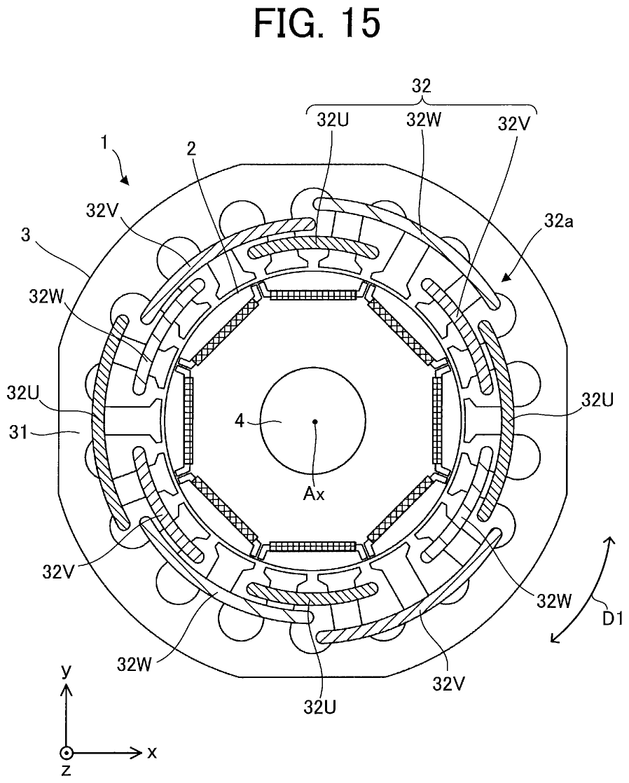

FIG. 15 is a top view schematically illustrating a structure of an electric motor 1 according to a variation.

In this variation, the value of “n” is different from the value of “n” described in first embodiment. In the variation, n=2. In the variation, a part of the configuration different from that of the first embodiment will be described. Details not described in the variation can be the same as those in the first embodiment.

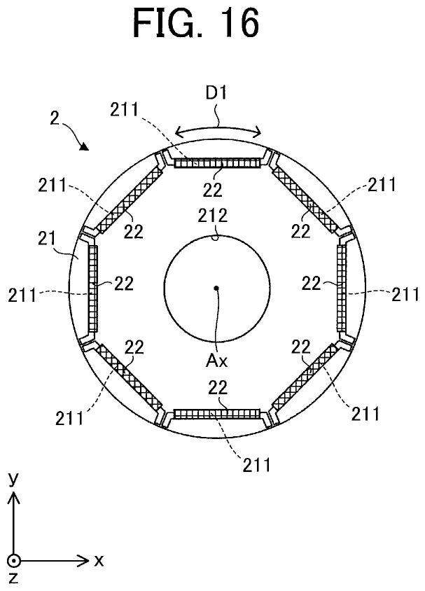

FIG. 16 is a cross-sectional view schematically illustrating a structure of a rotor 2 of the electric motor 1 according to the variation.

The rotor 2 includes a rotor core 21 and at least one permanent magnet 22. The rotor 2 has 4×n (n is an integer equal to or larger than 1) magnetic poles. In the variation, the rotor 2 has eight magnetic poles.

### <Stator 3>

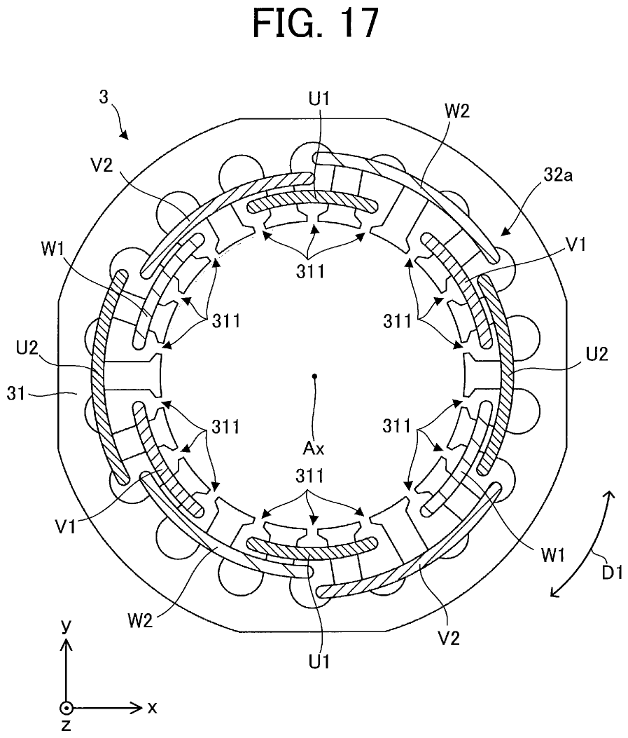

FIG. 17 is a top view schematically illustrating a structure of a stator 3 of the electric motor 1 according to the variation.

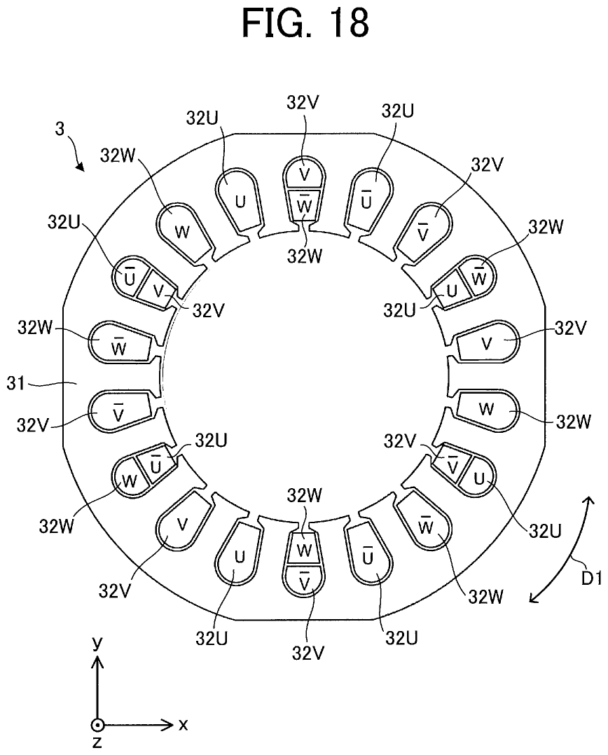

FIG. 18 is a diagram illustrating arrangement of three-phase coils 32 in slots 311 of the electric motor 1 according to the variation.

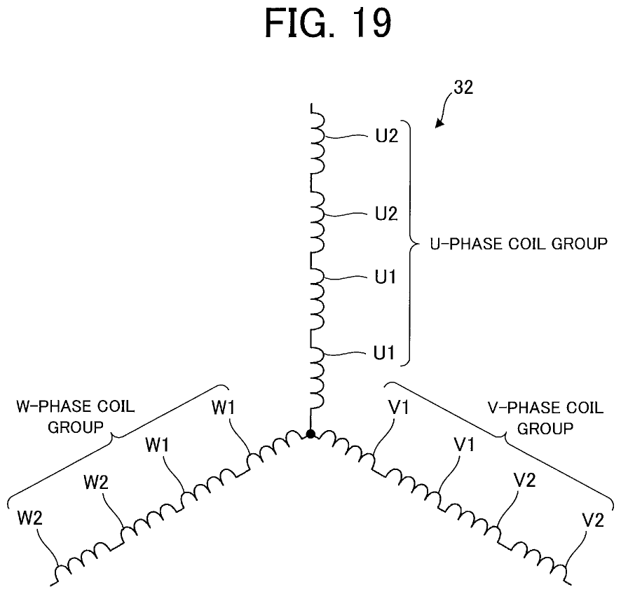

FIG. 19 is a diagram schematically illustrating the three-phase coils 32 of the electric motor 1 according to the variation.

The stator core 31 has 9×n slots 311 in which the three-phase coils 32 are disposed. In the variation, n=2. Thus, in the variation, the stator core 31 has 18 slots 311.

In the variation, n=2. Thus, in the example illustrated in FIG. 15, in the coil ends 32a, the three-phase coils 32 include four U-phase coils 32U, four V-phase coils 32V, and four W-phase coils 32W.

When current flows in the three-phase coils 32, the three-phase coils 32 form 4×n magnetic poles. In the variation, n=2. Thus, in the variation, when current flows through the three-phase coils 32, the three-phase coils 32 form eight magnetic poles.

In the variation, the coil group of each phase includes two first coils and two second coils. The first coils are arranged in the stator core 31 at two-slot pitch. The second coils are arranged in the stator core 31 at three-slot pitch.

As illustrated in FIG. 19, the 2×n U-phase coils 32U (i.e., the two first coils U1 and the two second coils U2), the 2×n V-phase coils 32V (i.e., the two first coils V1 and the two second coils V2), and the 2×n W-phase coils 32W (i.e., the two first coils W1 and the two second coils W2) are connected by, for example, Y connection. Alternatively, the 2×n U-phase coils 32U, the 2×n V-phase coils 32V, and the 2×n W-phase coils 32W may be connected by connection other than Y connection, such as delta connection.

### <U-Phase Coils 32U>

The 2×n U-phase coils 32U include n first coil(s) U1 and n second coil(s) U2. In the variation, the four U-phase coils 32U are constituted by two first coils U1 and two second coils U2. The 2×n U-phase coils 32U are connected in series. Thus, in the variation, two first coils U1 and two second coils U2 are connected in series. The first coils U1 are disposed in the stator core 31 at two-slot pitch. The second coils U2 are disposed in the stator core 31 at three-slot pitch.

In the case of n≥2, the n first coil(s) U1 is disposed in the coil ends 32a every 360/n degrees in the circumferential direction at regular intervals. In the variation, the two first coils U1 of the U phase are arranged in the coil ends 32a every 180 degrees in the circumferential direction at regular intervals. In other words, the n first coils U1 are shifted from one another by 360/n degrees and arranged at regular intervals in the coil ends 32a. In the variation, the two first coils U1 of the U phase are shifted from each other by 180 degrees and arranged at regular intervals in the coil ends 32a.

In the case of n≥2, the n second coil(s) U2 is disposed in the coil ends 32a every 360/n degrees in the circumferential direction at regular intervals. In the variation, the two second coils U2 of the U phase are arranged in the coil ends 32a every 180 degrees in the circumferential direction at regular intervals. In other words, the n second coils U2 are shifted from one another by 360/n degrees and arranged at regular intervals in the coil ends 32a. In the variation, the two second coils U2 of the U phase are shifted from each other by 180 degrees and arranged at regular intervals in the coil ends 32a.

### <V-Phase Coils 32V>

The 2×n V-phase coils 32V include n first coil(s) V1 and n second coil(s) V2. In the variation, the four V-phase coils 32V are constituted by two first coils V1 and two second coils V2. The 2×n V-phase coils 32V are connected in series. Thus, in the variation, the two first coils V1 and the two second coils V2 are connected in series. The first coils V1 are disposed in the stator core 31 at two-slot pitch. The second coils V2 are disposed in the stator core 31 at three-slot pitch.

In the case of n≥2, the n first coil(s) V1 is disposed in the coil ends 32a every 360/n degrees in the circumferential direction at regular intervals. In the variation, the two first coils V1 of the V phase are arranged in the coil ends 32a every 180 degrees in the circumferential direction at regular intervals. In other words, the n first coils V1 are shifted from one another by 360/n degrees and arranged at regular intervals in the coil ends 32a. In the variation, the two first coils V1 of the V phase are shifted from each other by 180 degrees and arranged at regular intervals in the coil ends 32a.

In the case of n≥2, the n second coil(s) V2 is disposed in the coil ends 32a every 360/n degrees in the circumferential direction at regular intervals. In the variation, the two second coils V2 of the V phase are arranged in the coil ends 32a every 180 degrees in the circumferential direction at regular intervals. In other words, the n second coils V2 are shifted from one another by 360/n degrees and arranged at regular intervals in the coil ends 32a. In the variation, the two second coils V2 of the V phase are shifted from each other by 180 degrees and arranged at regular intervals in the coil ends 32a.

### <W-Phase Coils 32W>

The 2×n W-phase coils 32W include n first coil(s) W1 and n second coil(s) W2. In the variation, the four W-phase coils 32W are constituted by two first coils W1 and two second coils W2. The 2×n W-phase coils 32W are connected in series. Thus, in the variation, the two first coils W1 and the two second coils W2 are connected in series. The first coils W1 are disposed in the stator core 31 at two-slot pitch. The second coils W2 are disposed in the stator core 31 at three-slot pitch.

In the case of n≥2, the n first coil(s) W1 is disposed in the coil ends 32a every 360/n degrees in the circumferential direction at regular intervals. In the variation, the two first coils W1 of the W phase are disposed in the coil ends 32a every 180 degrees in the circumferential direction at regular intervals. In other words, the n first coils W1 are shifted from one another by 360/n degrees and arranged at regular intervals in the coil ends 32a. In the variation, the two first coils W1 of the W phase are shifted from each other by 180 degrees and arranged at regular intervals in the coil ends 32a.

In the case of n≥2, the n second coil(s) W2 is disposed in the coil ends 32a every 360/n degrees in the circumferential direction at regular intervals. In the variation, the two second coils W2 of the W phase are disposed in the coil ends 32a every 180 degrees in the circumferential direction at regular intervals. In other words, the n second coils W2 are shifted from one another by 360/n degrees and arranged at regular intervals in the coil ends 32a. In the variation, the two second coils W2 of the W phase are shifted from each other by 180 degrees and arranged at regular intervals in the coil ends 32a.

### <Winding Factor>

The ratio N1/N2 described in the first embodiment is also applicable to the stator 3 of the electric motor 1 according to the variation.

### Second Embodiment

A compressor 300 according to a second embodiment will be described.

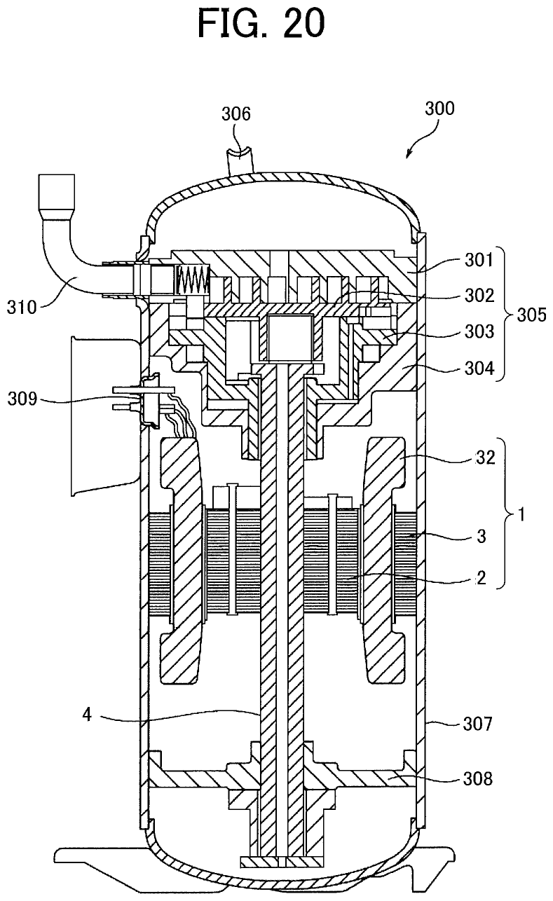

FIG. 20 is a cross-sectional view schematically illustrating a structure of the compressor 300.

The compressor 300 includes an electric motor 1 as an electric element, a closed container 307 as a housing, and a compression mechanism 305 as a compression element (also referred to as a compression device). In this embodiment, the compressor 300 is a scroll compressor. The compressor 300 is not limited to the scroll compressor. The compressor 300 may be a compressor except for the scroll compressor, such as a rotary compressor.

The electric motor 1 in the compressor 300 is the electric motor 1 described in the first embodiment (including the variation). The electric motor 1 drives the compression mechanism 305.

The compressor 300 includes a subframe 308 supporting a lower end (i.e., an end opposite to the compression mechanism 305) of a shaft 4.

The compression mechanism 305 is disposed inside the closed container 307. The compressor mechanism 305 includes a fixed scroll 301 having a spiral portion, a swing scroll 302 having a spiral portion forming a compression chamber between the spiral portion of the swing scroll 302 and the spiral portion of the fixed scroll 301, a compliance frame 303 holding an upper end of the shaft 4, and a guide frame 304 fixed to the closed container 307 and holding the compliance frame 303.

A suction pipe 310 penetrating the closed container 307 is press fitted in the fixed scroll 301. The closed container 307 is provided with a discharge pipe 306 that discharges a high-pressure refrigerant gas discharged from the fixed scroll 301 to the outside. The discharge pipe 306 communicates with an opening disposed between the compressor mechanism 305 of the closed container 307 and the electric motor 1.

The electric motor 1 is fixed to the closed container 307 by fitting the stator 3 in the closed container 307. The configuration of the electric motor 1 has been described above. To the closed container 307, a glass terminal 309 for supplying electric power to the electric motor 1 is fixed by welding.

When the electric motor 1 rotates, this rotation is transferred to the swing scroll 302, and the swing scroll 302 swings. When the swing scroll 302 swings, the volume of the compression chamber formed by the spiral portion of the swing scroll 302 and the spiral portion of the fixed scroll 301 changes. Then, a refrigerant gas is sucked from the suction pipe 310, compressed, and then discharged from the discharge pipe 306.

The compressor 300 includes the electric motor 1 described in the first embodiment, and thus, has advantages described in the first embodiment.

In addition, since the compressor 300 includes the electric motor 1 described in the first embodiment, performance of the compressor 300 can be improved.

### Third Embodiment

A refrigeration air conditioning apparatus 7 serving as an air conditioner and including the compressor 300 according to the second embodiment will be described.

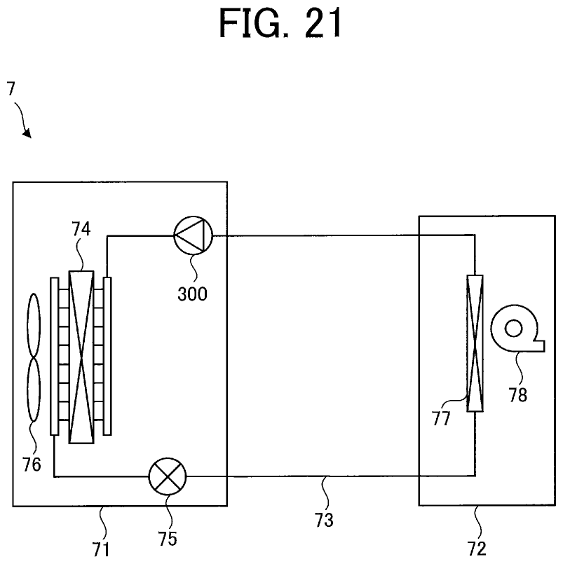

FIG. 21 is a diagram schematically illustrating a configuration of the refrigerating air conditioning apparatus 7 according to the third embodiment.

The refrigeration air conditioning apparatus 7 is capable of performing cooling and heating operations, for example. A refrigerant circuit diagram illustrated in FIG. 21 is an example of a refrigerant circuit diagram of an air conditioner capable of performing a cooling operation.

The refrigeration air conditioning apparatus 7 according to the third embodiment includes an outdoor unit 71, an indoor unit 72, and a refrigerant pipe 73 connecting the outdoor unit 71 and the indoor unit 72.

The outdoor unit 71 includes a compressor 300, a condenser 74 as a heat exchanger, a throttling device 75, and an outdoor air blower 76 (first air blower). The condenser 74 condenses a refrigerant compressed by the compressor 300. The throttling device 75 decompresses refrigerant condensed by the condenser 74, thereby adjusting a flow rate of the refrigerant. The throttling device 75 will be also referred to as a decompression device.

The indoor unit 72 includes an evaporator 77 as a heat exchanger, and an indoor air blower 78 (second air blower). The evaporator 77 evaporates refrigerant decompressed by the throttling device 75 to thereby cool indoor air.

A basic operation of a cooling operation in the refrigeration air conditioning apparatus 7 will now be described. In the cooling operation, refrigerant is compressed by the compressor 300 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 300 of the outdoor unit 71 again. When the air is sent to the condenser 74 by the outdoor air blower 76, heat moves between refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present invention is not limited to the examples described above.

The refrigeration air conditioning apparatus 7 according to the third embodiment has the advantages described in the first embodiment.

In addition, since the refrigeration air conditioning apparatus 7 according to the third embodiment includes the compressor 300 according to the second embodiment, performance of the refrigeration air conditioning apparatus 7 can be improved.

Features of the embodiments described above and features of the variation can be combined.

### DESCRIPTION OF REFERENCE CHARACTERS

1 electric motor, 2 rotor, 3 stator, 7 refrigeration air conditioning apparatus, 31 stator core, 32 three-phase coil, 32a coil end, 32U U-phase coil, 32V V-phase coil, 32W W-phase coil, 71 outdoor unit, 72 indoor unit, 74 condenser, 77 evaporator, 300 compressor, 305 compression mechanism, 307 closed container, 311 slot, U1, V1, W1 first coil, U2, V2, W2 second coil.

1. A stator comprising:
a stator core including 9×n (n is an integer equal to or larger than 1) slots; and
three-phase coils attached to the stator core by distributed winding and to form 4×n magnetic poles, wherein
the three-phase coils include 2×n U-phase coils, 2×n V-phase coils, and 2×n W-phase coils in a coil end of the three-phase coils,
the 2×n U-phase coils are connected in series,
the 2×n V-phase coils are connected in series,
the 2×n W-phase coils are connected in series,
each of the 2×n U-phase coils, the 2×n V-phase coils, and the 2×n W-phase coils includes n first coil(s) disposed in the stator core at two-slot pitch and n second coil(s) disposed in the stator core at three-slot pitch,
the n first coil(s) is disposed in the coil end every 360/n degrees in a circumferential direction at regular intervals,
the n second coil(s) is disposed in the coil end every 360/n degrees in the circumferential direction at regular intervals, and
the stator satisfies 0.928≤N1/N2<2 or 2<N1/N2≤3.294, where N1 is the number of turns of each of the n first coil(s) and N2 is the number of turns of each of the n second coil(s).

2. A stator comprising:
a stator core including 9×n (n is an integer equal to or larger than 1) slots; and
three-phase coils attached to the stator core by distributed winding and to form 4×n magnetic poles, wherein
the three-phase coils include 2×n U-phase coils, 2×n V-phase coils, and 2×n W-phase coils in a coil end of the three-phase coils,
the 2×n U-phase coils are connected in series,
the 2×n V-phase coils are connected in series,
the 2×n W-phase coils are connected in series,
each of the 2×n U-phase coils, the 2×n V-phase coils, and the 2×n W-phase coils includes n first coil(s) disposed in the stator core at two-slot pitch and n second coil(s) disposed in the stator core at three-slot pitch,
the n first coil(s) is disposed in the coil end every 360/n degrees in a circumferential direction at regular intervals,
the n second coil(s) is disposed in the coil end every 360/n degrees in the circumferential direction at regular intervals, and
the stator satisfies 1.117≤N1/N2≤1.634 or 2.244≤N1/N2≤2.876, where N1 is the number of turns of each of the n first coil(s) and N2 is the number of turns of each of the n second coil(s).

3. A stator comprising:
a stator core including 9×n (n is an integer equal to or larger than 1) slots; and
three-phase coils attached to the stator core by distributed winding and to form 4×n magnetic poles, wherein
the three-phase coils include 2×n U-phase coils, 2×n V-phase coils, and 2×n W-phase coils in a coil end of the three-phase coils,
the 2×n U-phase coils are connected in series,
the 2×n V-phase coils are connected in series,
the 2×n W-phase coils are connected in series,
each of the 2×n U-phase coils, the 2×n V-phase coils, and the 2×n W-phase coils includes n first coil(s) disposed in the stator core at two-slot pitch and n second coil(s) disposed in the stator core at three-slot pitch,
the n first coil(s) is disposed in the coil end every 360/n degrees in a circumferential direction at regular intervals,
the n second coil(s) is disposed in the coil end every 360/n degrees in the circumferential direction at regular intervals, and
the stator satisfies 1.347≤N1/N2≤2.532, where N1 is the number of turns of each of the n first coil(s) and N2 is the number of turns of each of the n second coil(s).

4. A stator comprising:
a stator core including 9×n (n is an integer equal to or larger than 1) slots; and
three-phase coils attached to the stator core by distributed winding and to form 4×n magnetic poles, wherein
the three-phase coils include 2×n U-phase coils, 2×n V-phase coils, and 2×n W-phase coils in a coil end of the three-phase coils,
the 2×n U-phase coils are connected in series,
the 2×n V-phase coils are connected in series,
the 2×n W-phase coils are connected in series,
each of the 2×n U-phase coils, the 2×n V-phase coils, and the 2×n W-phase coils includes n first coil(s) disposed in the stator core at two-slot pitch and n second coil(s) disposed in the stator core at three-slot pitch,
the n first coil(s) is disposed in the coil end every 360/n degrees in a circumferential direction at regular intervals,
the n second coil(s) is disposed in the coil end every 360/n degrees in the circumferential direction at regular intervals, and
the stator satisfies 0.928≤N1/N2<2, where N1 is the number of turns of each of the n first coil(s) and N2 is the number of turns of each of the n second coil(s).

5. A stator comprising:
a stator core including 9×n (n is an integer equal to or larger than 1) slots; and
three-phase coils attached to the stator core by distributed winding and to form 4×n magnetic poles, wherein
the three-phase coils include 2×n U-phase coils, 2×n V-phase coils, and 2×n W-phase coils in a coil end of the three-phase coil,
the 2×n U-phase coils are connected in series,
the 2×n V-phase coils are connected in series,
the 2×n W-phase coils are connected in series,
each of the 2×n U-phase coils, the 2×n V-phase coils, and the 2×n W-phase coils includes n first coil(s) disposed in the stator core at two-slot pitch and n second coil(s) disposed in the stator core at three-slot pitch,
the n first coil(s) is disposed in the coil end every 360/n degrees in a circumferential direction at regular intervals,
the n second coil(s) is disposed in the coil end every 360/n degrees in the circumferential direction at regular intervals, and
the stator satisfies 2<N1/N2≤3.294, where N1 is the number of turns of each of the n first coil(s) and N2 is the number of turns of each of the n second coil(s).

6. The stator according to claim 1, wherein
the 2×n U-phase
coils, the 2×n V-phase coils, and the 2×n W-phase coils are connected to one another by Y connection.

7. The stator according to claim 1, wherein a distributed winding factor of the stator is 1.

8. An electric motor comprising:
the stator according to claim 1; and
a rotor disposed inside the stator.

9. A compressor comprising:
a closed container;
a compression device disposed in the closed container; and
the electric motor according to claim 8 to drive the compression device.

10. An air conditioner comprising:
the compressor according to claim 9; and
a heat exchanger.
